(19) United States
(12) Patent Application Publication
(10) Pub. No.: US 2019/0207345 A1
(43) Pub. Date: Jul. 4, 2019

(54) Locking Clip for a Plug Connector Housing

(71) Applicant: HARTING ELECTRIC GMBH & CO. KG, Espelkamp (DE)

(72) Inventor: Nicole SPILKER, Lübbecke (DE)

(73) Assignee: HARTING Electric GmbH & Co. KG, Espelkamp (DE)

(21) Appl. No.: 16/325,220

(22) PCT Filed: Oct. 16, 2017
(86) PCT No.: PCT/DE2017/100880

§ 371 Date: Feb. 13, 2019

(30) Foreign Application Priority Data
Nov. 3, 2016 (DE) 10 2016 120 929.5

(51) Int. Cl. H01R 13/629; H01R 43/26

(52) U.S. Cl. CPC H01R 13/62966; H01R 43/26; H01R 13/62955

(57) ABSTRACT

The invention relates to a locking device for plug connector housings, wherein the locking device (1) can be mounted pivotably on a first plug connector housing (12), wherein the locking device (1) can be locked on a second plug connector housing (14), as a result of which the first and the second plug connector housings (12, 14) can be pressed resiliently against each other. The locking device has means which prevent inadvertent opening of a closed plug connection. This makes it possible to avoid machine failures and accidents. The invention also relates to a method for releasing a first plug connector housing (12) from a second plug connector housing (14) with a locking device (1) which is mounted pivotably on the first plug connector housing (12) and can be locked on the second plug connector housing (14), wherein a force required for a pivoting-open movement increases abruptly during the pivoting-open movement.

### TECHNICAL FIELD

The invention relates to a locking clip for plug connector housings and to a method for unlocking two plug connector housings.

### BACKGROUND

Locking clips are used to lock in a reversible manner two plug connector housings that are plugged together.

DE 29 15 574 A1 illustrates a locking clip for locking a first plug connector housing to a second plug connector housing in a reversible manner. The locking clip is manufactured from a resilient wire.

DE 10 2004 061 046 B4 illustrates a locking clip that is stamped out of a sheet metal piece and produces a resilient locking arrangement between two plug connector housings.

Since the plug connector housings are protected on the plugging side by means of a rubber seal to prevent media from penetrating, it is not possible to dimension the resilient force of the locking clip to be too high since the seal could otherwise become damaged and lose its sealing effect. If the cables that are connected to the plug connecter are unintentionally subjected to a pulling load, the above described locking clip may fail and the plug connection may be inadvertently unlocked. This may lead by way of example to machines undesirably coming to a standstill.

The object of the invention is to propose a reliable and reversible locking clip for plug connectors.

### SUMMARY

A locking clip in accordance with the invention is used to lock together in a reversible manner a first and a second plug connector housing in the plugged-in state. The plug connector housings may comprise electrical, pneumatic and/or FOC-contact elements. It should not be possible to inadvertently release the contacting arrangement of the plug connector housings in the plugged-in state.

The locking clip may be mounted in such a manner as to be able to pivot on a first plug connector housing. The locking clip may comprise for this purpose two pivot holes that are arranged at the end and which may engage with pivot pins that are integrally formed on the first plug connector housing.

The locking clip may be locked to a second plug connector housing. The locking clip may comprise for this purpose receiving slots that may engage locking pins that are integrally formed on the second plug connector housing.

The first and the second plug connector housing are pressed together in a resilient manner by the locking clip.

The two plug connector housings are locked together via a pivot movement of the locking clip in the direction of the second plug connector housing. A pivot movement of the locking clip away from the second plug connector housing unlocks the connection.

The locking clip comprises means that prevent a plug connection between two plug connector housings from being unintentionally or inadvertently opened. It is thereby possible to prevent that two plug connectors that are plugged together are pulled apart inadvertently. The means are provided by the shape and the construction of the locking clip.

The locking clip may be configured in an essentially U-shaped manner. The locking clip comprises a rear wall from which two lateral arms are bent outward at a 90° angle. The lateral arms are each divided into a lower arm and an upper arm. Accordingly, the upper and the lower arm are formed integrally on a rear wall.

The upper and the lower arm each comprise at least one lever. The upper arm lever of the upper arm and the associated lower arm lever of the lower arm overlap one another and are oriented parallel to one another. The levers are each used as a stopping point when a specific force is exerted in a pivot movement of the locking clip away from the second plug connector housing (opening pivot movement).

In an advantageous embodiment of the invention, during the unlocking procedure the locking clip is influenced by a first force over a first travel path and by a second force over a second travel path. In so doing, the first force is less than the second force. During the first travel path, the levers of the upper and lower arm are brought together. During the second travel path, the levers are in contact with one another as a result of which the required force application to produce a further pivot movement is increased.

The lower arm is advantageously provided in each case with a pivot hole that is integrally formed thereon and by which the locking clip may be pivotably mounted on two pivot pins in such a manner as to be able to rotate on the first plug connector housing, said pivot pins being oriented in a coaxial manner with respect to one another. The respective upper arm is provided in each case with a receiving slot by which the locking clip may be locked to two locking pins of the second plug connector housing, said locking pins being oriented in a coaxial manner with respect to one another.

It is preferred that the locking clip comprises an actuating grip. It is possible via the actuating grip to exert the above described force or rather the different forces for the opening pivot movement. The actuating grip is integrally formed on the rear wall.

The locking clip is preferably made from a resilient metal sheet. A locking clip of this type may be stamped out of a sheet metal piece and bent accordingly into shape. A manufacturing method of this type is very cost-effective to perform.

The locking clip comprises a rear wall and lateral arms that are bent out of said rear wall at a 90° angle. The lateral arms may each be divided into an upper arm and a lower arm. Accordingly, a locking clip that is configured in such a manner comprises two upper arms and two lower arms that each comprise a lever. The upper arm lever of the upper arm is oriented parallel to the lower arm lever of the lower arm. Moreover, the aforementioned arm levers overlap one another at least in part in the pivot direction or rather within the pivot plane.

In other words, the locking clip comprises levers that overlap on both sides, are oriented in a parallel manner, come into contact with one another during the opening pivot movement and produce a greater resistance during the opening pivot movement. It is necessary until the levers come into contact with one another during the opening pivot movement to initially use a first force that is than a second force that must be used if the arm levers are in contact with one another. A discontinuity in the graph could be established in a path-force diagram at the moment the arm levers come into contact with one another. The clip at this point is therefore only moved against an increased resistance that is clearly perceivable for the user. The above described increase in resistance during the opening pivot movement prevents the plugged-in and locked plug connector housings from being unintentionally pulled apart.

An opening pivot movement with the locking clip in accordance with the invention may be described via two or three different states:

The plug connector housings are locked together. In the first state, the above described levers are oriented parallel to one another in the pivot direction and overlap one another at least in part. The levers are spaced apart from one another, in other words the distance between the arm levers is greater than zero. The levers are located in the same plane with the result that it is possible to bring them into contact with one another. The above described pivot movement is performed along a first pivot axis that lies in the region of the rear wall or rather on the rear wall. The rear wall is bent during this pivot movement.

During the opening pivot movement of the locking clip along a first travel path, the above mentioned levers are brought into contact with one another. The distance between the levers is equal to zero in this case. The pivot movement now moves into a second state. During the further pivot movement of the locking clip, the levers continue to remain in contact with one another. The locking clip is moved in so doing about a second axis of rotation. The second axis of rotation is formed by the connecting line of the pivot pins of the first plug connector housing. The further pivot movement must be performed with a greater application of force than the first pivot movement during which the levers are not yet in contact with one another. The force that is required for the opening pivot movement increases in a step function from this moment onward. The receiving slots are pivoted outward over the locking pins of the second plug connector housing.

In the third state, the locking pins of the second plug connector housing are not gripped by the receiving slots of the locking clip.

It is possible using the illustrated locking clip with relatively low actuating forces to achieve very high retaining forces. The locking unit is overall very user friendly.

### BRIEF DESCRIPTION OF THE DRAWINGS

An exemplary embodiment of the invention is illustrated in the drawings and explained in detail below.

FIG. 1 illustrates a lateral view of a locking clip.

FIG. 2 illustrates a perspective view of the locking clip.

FIG. 3 illustrates a schematic sketch of two plug connector housings that are locked by the locking clip.

FIG. 4a illustrates a schematic view of an opening pivot movement of the locking clip.

FIG. 4b illustrates a further schematic view of an opening pivot movement of the locking clip.

FIG. 4c illustrates a further schematic view of an opening pivot movement of the locking clip.

### DETAILED DESCRIPTION

The figures illustrate in part simplified, schematic views. Identical reference numerals are sometimes used for identical but where appropriate non-identical elements. Different aspects of identical elements may be scaled differently.

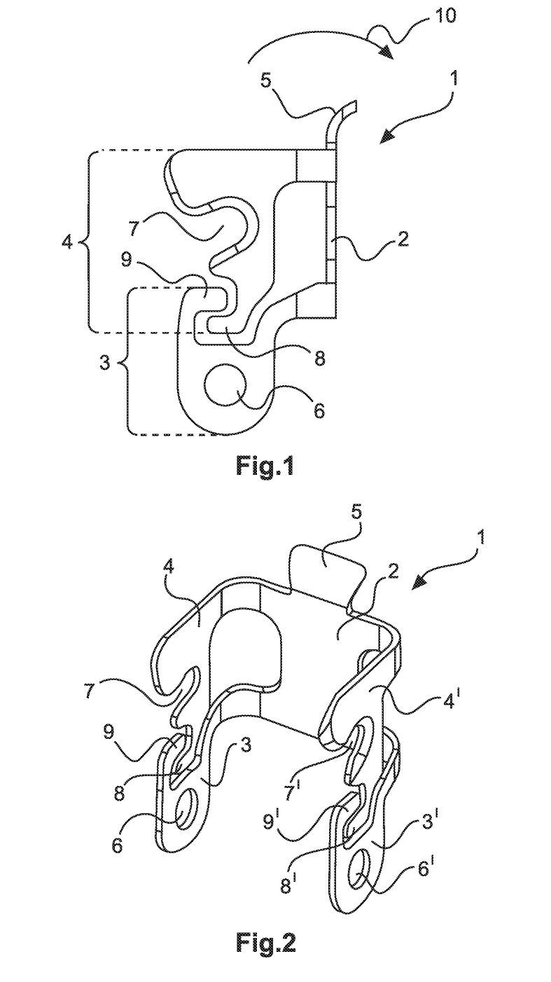

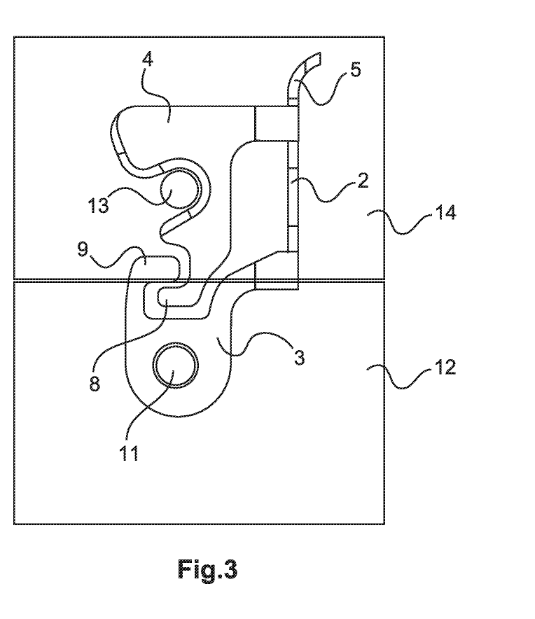

FIGS. 1 and 2 illustrate a locking clip 1. Such a locking clip may be manufactured by stamping out the contour from a flat sheet metal piece and subsequently performing a bending procedure.

The locking clip 1 has a U-shaped cross section and is configured essentially from a rear wall 2 from which two lateral arms are bent outward. The lateral arms comprise in each case an upper arm 4 and a lower arm 3. An actuating grip 5 is integrally formed on the rear wall 2. It is possible to operate the locking clip 1 manually using the actuating grip 5.

A pivot hole 6, 6′ in the form of an opening is provided in the lower arm 3, 3′. This renders it possible to mount the locking clip 1 in a pivotable manner on two pivot pins 11 of a first plug connector housing 12. A receiving slot 7, 7′ is integrally formed in the upper arm 4, 4′. The receiving slot 7, 7′ may engage a locking pin 13 of a second plug connector housing 14, whereby the first plug connector housing 12 and the second plug connector housing 14 are pressed against one another in a resilient manner.

An upper arm lever 8, 8′ on the upper arm 4 is oriented parallel to a lower arm lever 9, 9′ of the lower arm 3. The levers are spaced apart by 0.6 mm up to 2 mm (millimeter), particularly preferred however by 1.2 mm to 1.8 mm with respect to one another. If the locking clip 1 is pivoted in the direction of the arrow 10 away from the second plug connector housing 14 in the direction of the arrow 10, the resilient rear wall 2 or rather the upper arm 4 that is connected thereto is bent by means of the prevailing first force. As a consequence, the upper arm levers 8, 8′ of the upper arms 4, 4′ come into contact with the lower arm levers 9, 9′ of the lower arms 3, 3′. A user now notices an increased resistance in the pivot movement. The force required for the opening pivot movement increases in a step from this point onward. In order now to pivot the locking clip 1 completely away from the locking pin 13 of the second plug connector housing 14, it is necessary to apply a second force that is greater than the previous first force.

A short description is provided below of the method with which two plug connector housings that are plugged together may be unlocked.

Initially, (a) the locking clip 1 is pivoted away from the second plug connector housing 14 along a first travel path. In so doing, the upper arm lever 8 of the upper arm 4 or rather the upper arm levers 8, 8′ of the upper arms 4, 4′ are moved in the direction of the lower arm lever 9 of the lower arm 3 or rather of the lower arm levers 9, 9′ of the lower arms 3, 3′. In so doing, the said lower arm levers of the lower arms 9, 9′ are brought into contact with the upper arm levers 8, 8′ of the upper arms 4.

Subsequently (b), the locking clip 1 is pivoted away from the second plug connector housing 14 along a further second travel path. In so doing, the upper arm lever 8, 8′ of the upper arm 4, 4′ or rather the upper arm levers 8, 8′ of the upper arms 4, 4′ remain in contact with the lower arm lever 9, 9′ of the lower arm 3, 3′ or rather with the lower arm levers 9, 9′ of the lower arms 3, 3′.

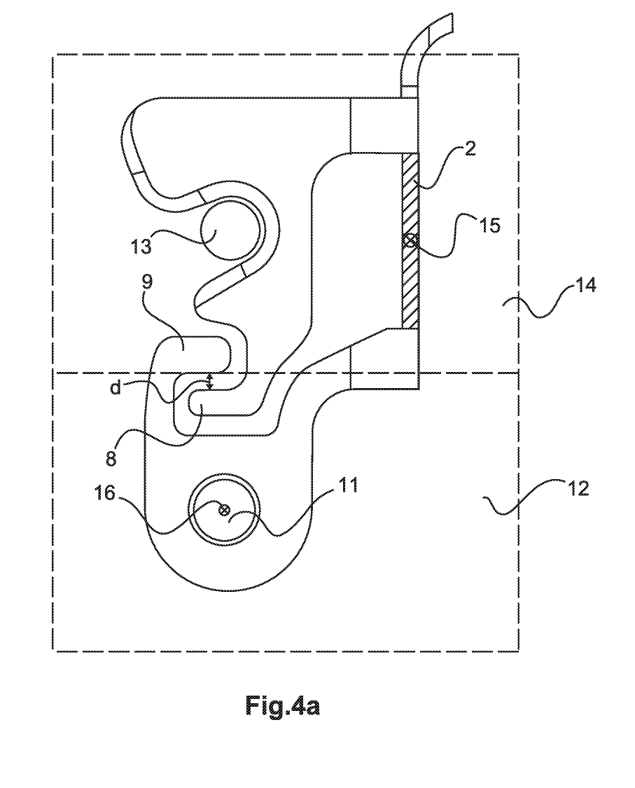

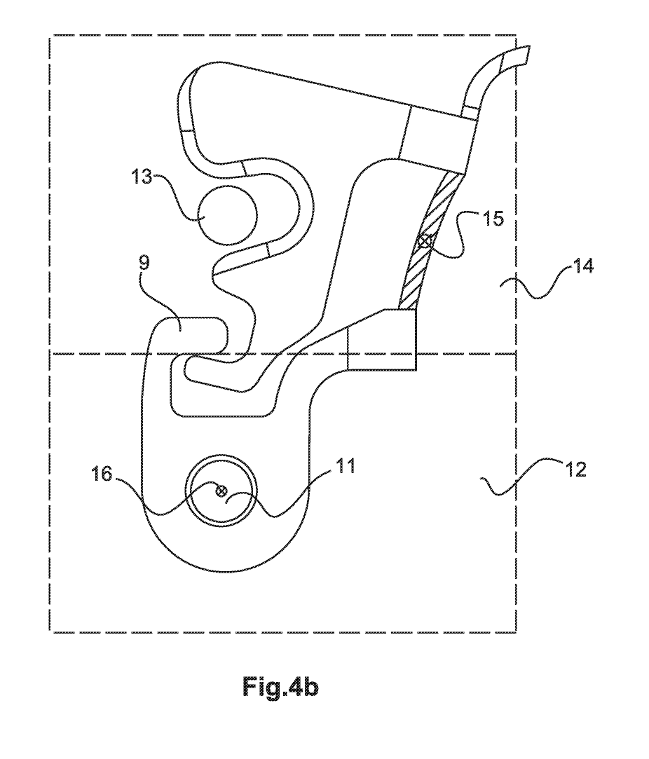

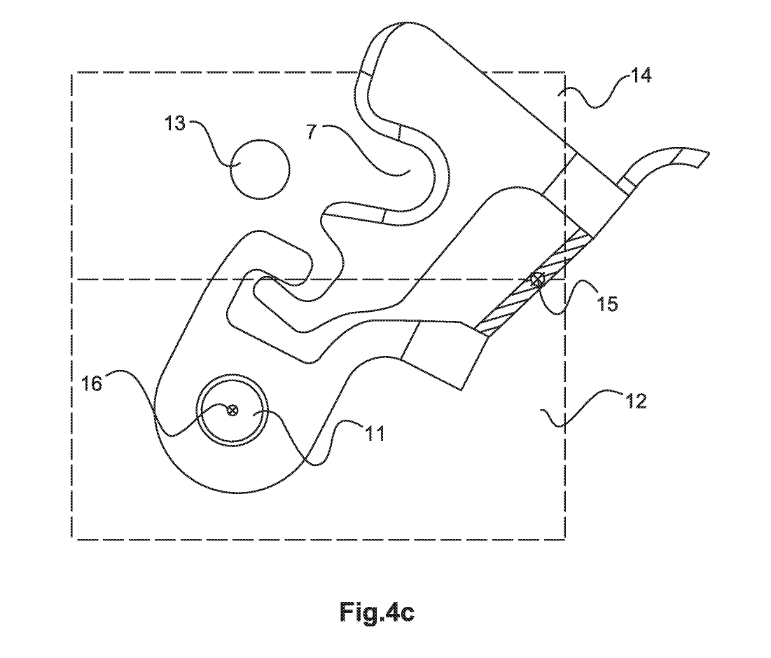

An opening pivot movement of a possible embodiment of the locking clip 1 is illustrated schematically in FIGS. 4a-c. For illustration reasons, the plug connector housings 12, 14 are only indicated by broken lines. The opening pivot movement with the locking clip 1 in accordance with the invention may be described via two or three different states:

The plug connector housings 12, 14 are locked together. In the first state, the above described levers 8, 9 are oriented parallel to one another in the pivot direction and overlap one another at least in part. The levers 8, 9 are spaced apart from one another. The distance d between the levers 8, 9 is greater than zero. The arm levers are located in the same plane with the result that it is possible to bring them into contact with one another. The above described pivot movement is performed along a first axis of rotation 15 that lies in the region of the rear wall 2 or rather on the rear wall 2. The rear wall 2 is bent during this pivot movement, as is apparent in FIG. 4b.

During the opening pivot movement of the locking clip 1 along a first travel path, the above mentioned arm levers 8, 9 are brought into contact with one another. The distance d between the arm levers is equal to zero in this case. The pivot movement now moves into a second state. During the further pivot movement of the locking clip 1, the arm levers 8, 9 remain in contact with one another as in the following description. The locking clip 1 is moved in so doing along a second axis of rotation 16. The second axis of rotation 16 is formed by the connecting line of the pivot pins 11 of the first plug connector housing 12. The further pivot movement must be performed with a greater application of force than the first pivot movement during which the arm levers 8, 9 are not yet in contact with one another. The receiving slots 7 are pivoted away over the locking pins of the second plug connector housing 14.

The third state of the opening pivot movement is apparent in FIG. 4c. In the third state, the locking pins 13 of the second plug connector housing 14 are not gripped by the receiving slots 7 of the locking clip 1.

During the closing pivot movement of the locking clip 1—in the opposite direction to the arrow 10—the arm levers 8, 9 are in contact with one another. If the locking clip 1 is pivoted over the locking pins 13, 13′, the contact is removed and a defined distance d becomes apparent between the upper arm levers 8, 8′ and the lower arm lever 9, 9′. The distance d defines the above mentioned distance between the upper and lower arm levers 8, 8′, 9, 9′ and is between 0.6 mm up to 2 mm, wherein the boundary values are specifically included. This distance has proven itself to be particularly advantageous both during the closing pivot movement and also during the opening pivot movement of the locking clip. The usability of the locking clip is thereby increased.

### LIST OF REFERENCE NUMERALS

1 Locking clip
2 Rear wall
3 Lower arm
4 Upper arm
5 Actuating grip
6 Pivot hole
7 Receiving slot
8 Upper Arm lever
9 Lower arm lever
10 Arrow
11 Pivot pin
12 First plug connector housing
13 Locking pin
14 Second plug connector housing
15 First axis of rotation
16 Second axis of rotation
d Distance

1-15. (canceled)

16. A locking clip for coupling a first connector housing to a second connector housing, comprising:
a rear wall;
lower arms arranged in parallel planes extending perpendicularly on opposite sides from a lower portion of the rear wall;
pivot holes formed coaxially in each of the lower arms;
upper arms arranged in the parallel planes extending perpendicularly on opposite sides from an upper portion of the rear wall, the upper arms being pivotable relative to the lower arms by bending the rear wall;
receiving slots, one receiving slot formed in each of the upper arms, each receiving slot extending inwardly towards the rear wall and upwardly away from the lower arm;
lower arm levers, one lower arm lever formed in each of the lower arms extending towards the rear wall; and
upper arm levers, one upper arm lever formed in each of the upper arms extending away from the rear wall, the upper arm levers being arranged below and at a distance from the lower arm levers,
wherein, in a locked position, the pivot holes are held by pivot pins of the first connector housing and the receiving slots engage locking pins of the second connector housing.

17. The locking clip as in claim 16, wherein the locking clip is disengaged from the second connector housing in a two-step motion, including
bending the rear wall and pivoting the upper arms relative to the lower arms until the upper arm levers push against the lower arm levers and
jointly pivoting the rear wall, the upper arms and the lower arms about the pivot holes while the upper arm levers push against the lower arm levers.

18. The locking clip as in claim 17,
wherein bending the rear wall and pivoting the upper arms relative to the lower arms requires applying a first force over a first travel path and
wherein jointly pivoting the rear wall, the upper arms and the lower arms about the pivot holes while the upper arm levers push against the lower arm levers requires applying a second force over a second travel path, the first force being smaller than the second force.

19. The locking clip as in claim 16,
wherein free ends of the lower arm levers are arranged above and overlap with free ends of the upper arm levers, and
wherein the lower arm levers and the upper arm levers are oriented parallel to one another.

20. The locking clip as in claim 16,
wherein a distance (d) between the lower arm levers and the upper arm levers is greater than zero when the locking clip is in a locked state and
wherein the distance (d) between the lower arm levers and the upper arm levers can be reduced to zero by bending the rear wall to disengage the locking clip.

21. The locking clip as in claim 20,
wherein reducing the distance (d) between the lower arm levers and the upper arm levers to zero requires applying a first force to the upper portion of the rear wall over a first travel path and
wherein disengaging the locking clip requires subsequent application of a greater second force to the upper portion of the rear wall over a second travel path while the upper arm levers and the lower arm levers are in contact with one another during the second travel path.

22. The locking clip as in claim 16,
wherein the rear wall, the upper arms and the lower arms are integrally formed as a single piece.

23. The locking clip as in claim 22,
wherein the locking clip is made of resilient sheet metal.

24. The locking clip as in claim 16,
wherein an actuating grip is formed on the rear wall.

25. The locking clip as in claim 24,
wherein the actuating grip is formed as an outwardly bent portion of the rear wall upwardly of the upper arms.

26. A method for unlocking a first connector housing from a second connector housing, comprising:
providing a locking clip having a lower portion which is pivotably held by pivot pins of the first connector housing and an upper portion which engages locking pins of the second connector housing; and
applying a variable force to an upper portion the locking clip to pivot the locking clip by a pivot angle,
wherein an amount of the variable force is a step function of the pivot angle.

27. The method as in claim 26,
wherein the upper portion of the locking clip comprises an upper arm including an upper arm lever and the lower portion of the locking clip comprises a lower arm having a lower arm lever, the upper arm lever and the lower arm lever being arranged in a common plane parallel to one another with overlapping ends,
wherein applying the variable force to the upper portion the locking clip causes the upper portion of the locking clip to pivot away from the second connector housing along a first travel path while the lower portion of the locking clip remains in place, thereby causing the upper arm lever to move towards and get in contact with the lower arm lever, and
wherein subsequent further applying the variable force to the upper portion the locking clip causes the locking clip to pivot away from the second connector housing along a further second travel path, while the upper arm lever remains in contact with the lower arm lever during the further second travel path.

28. The method as in claim 27, wherein
causing the upper portion of the locking clip to pivot away from the second connector housing along a first travel path requires a first force and
causing the locking clip to pivot away from the second connector housing along a further second travel path requires a second force, the second force being greater that the first force.

29. The method as in claim 27, wherein
pivoting of the upper portion of the locking clip to pivot away from the second connector housing along a first travel path is performed about a first axis of rotation and
pivoting the locking clip away from the second connector housing along the further second travel path is performed about a second axis of rotation, the second axis of rotation being spaced apart from the first axis of rotation.
